(19) United States
(12) Patent Application Publication
(10) Pub. No.: US 2004/0136011 A1
(43) Pub. Date: Jul. 15, 2004

(54) Reflective position measuring device and method

(76) Inventors: Leslie Christie JR., Greeley, CO (US); David W. Boyd, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/341,904

(22) Filed: Jan. 13, 2003

(51) Int. Cl. G01B 11/14

(52) U.S. Cl. 356/614

(57) ABSTRACT

A simple, inexpensive apparatus is disclosed for measuring position in a robotic mechanism. A light source illuminates a reflective target, and a light detector views the target, sensing light reflected from the target. By virtue of the characteristics of the light source, the shape and material of the target, and the arrangement of the light source, target, and detector, the intensity of light received by the detector varies with the relative position of the mechanism and the target. Optionally, a tube limits the field of view of the detector. The detector may be moved until a local maximum is found for the reflected light from the target. A method of operating the apparatus is also disclosed.

### FIELD OF THE INVENTION

The present invention relates generally to position detection, and more specifically to positional calibration of a robotic system used in a mass storage autochanger system.

### BACKGROUND OF THE INVENTION

A mass storage autochanger system serves as an example of a robotic positioning system. In a typical mass storage autochanger, sometimes called an automated library system, a robotic mechanism moves computer storage media units, such as optical disks or digital tape cartridges, between a magazine and one or more drives that can write data to or read data from the media units. Such a system is shown schematically in FIG. 1.

In the example schematic autochanger system of FIG. 1, magazine 101 holds several storage media units 102. Picker mechanism 103 translates vertically on shafts 104 driven by belt 105, which is in turn driven by motor 106. A gripper 107 translates horizontally, driven by lead screw 108, which is in turn driven by motor 109. This robotic mechanism can extract a storage media unit 102 from magazine 101 and place it into drive 110, where data may be read from or written to the storage media unit. The data is exchanged with a host computer via interface 111.

In this way, the autochanger system provides a large data storage capacity to the host computer, using fewer drives than storage media units. Of course, other configurations are used.

For proper operation of the autochanger system, the robotic mechanism must be able to accurately position the picker mechanism 103 in relation to the bays in magazine 101. The robotic mechanism typically uses a position measuring device such as an encoder to ascertain the position of picker mechanism 103. The encoder may be placed, for example, on the shaft of motor 106.

Due to various mechanical and electrical variations, the position measuring device may not be able to indicate the position of picker mechanism 103 accurately enough. For example, mechanical tolerance variations in the construction of the magazine 101 may cause the storage media units to be held in other than their nominal positions. Or variations in the dimensions of belt 105 or other mechanical components may cause the picker mechanism 103 to travel in other than its nominal trajectory. Or the electronic control system controlling the robotic mechanism may have inherent errors.

In addition, in order to make the autochanger system as small as possible, it is desirable to place the bays of magazine 101 as close together as possible. This results in more stringent accuracy requirements for the robotic mechanism. If the errors are significant with respect to the positioning requirements, the autochanger system may not reliably perform properly.

Prior autochanger systems have addressed this problem by placing one or more reflective targets on magazine 101, and placing an optical reader on picker mechanism 103. For example, see U.S. Pat. No. 6,331,714 to Gardner, Jr. et al. In the typical system of Gardner, a lens focuses an image of the reflective target onto an electronic sensor such as a charge coupled device. The picker mechanism is moved until the optical reader locates a reflective target, and the position of the picker mechanism is recorded. Because the target is placed accurately with respect to the magazine bays, the system can determine the actual position of a bay in relation to its nominal position. In this way, a calibration is constructed by which the nominal picker locations may be adjusted to correct for the various tolerance variations.

However, the optical reader of Gardner is complex and expensive, and requires precise alignment during its manufacture. There is a need for a simple, inexpensive detector for ascertaining the position of a robotic system such as the picker mechanism in an autochanger system.

### SUMMARY OF THE INVENTION

A simple, inexpensive apparatus is disclosed for measuring position in a robotic mechanism. A light source illuminates a reflective target, and a light detector views the target, sensing light reflected from the target. By virtue of the characteristics of the light source, the shape and material of the target, and the arrangement of the light source, target, and detector, the intensity of light received by the detector varies with the relative position of the mechanism and the target. Optionally, a tube limits the field of view of the detector. The detector may be moved until a local maximum is found for the reflected light from the target. A method of operating the apparatus is also disclosed.

### BRIEF DESCRIPTION OF THE DRAWINGS

FIG. 1 schematically depicts an example mass storage autochanger system.

FIG. 2A shows a cutaway view of an example embodiment of a detector incorporating the invention.

FIG. 2B illustrates the operation of the example detector of FIG. 2A.

FIG. 3 shows the position detector system of FIG. 2A in a position that maximizes the light falling on light sensor.

FIG. 4 shows the qualitative relationship between mechanism position and light intensity received by the light sensor.

FIG. 5 shows a close up view of the schematic autochanger system of FIG. 1 with an example embodiment of the position measuring system attached.

FIG. 6 shows an alternative example target embodiment that may be used if only one direction of motion is to be calibrated.

FIG. 7 shows an additional alternative example target embodiment.

### DETAILED DESCRIPTION OF THE PREFERRED EMBODIMENT

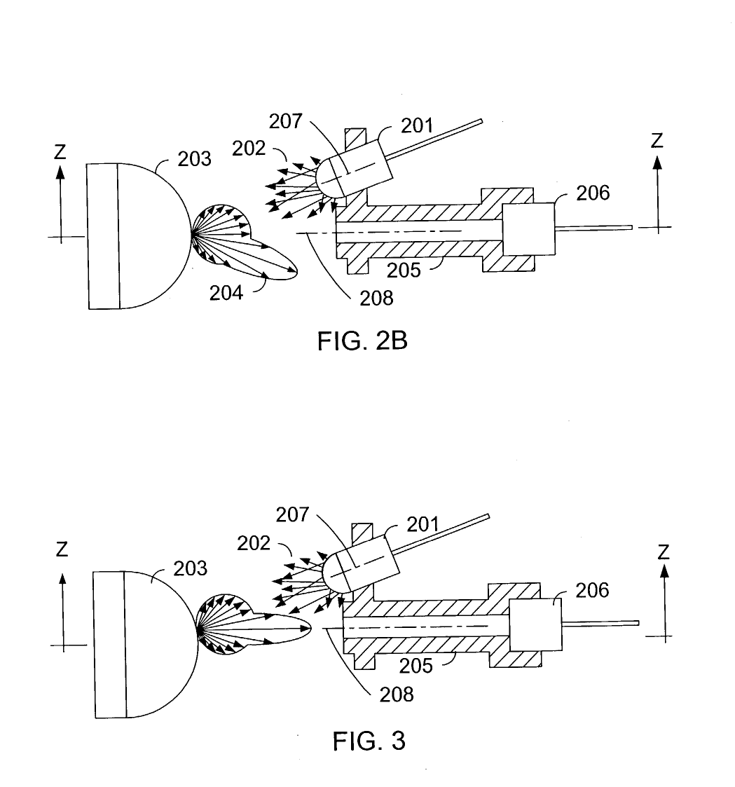

FIG. 2A shows a cutaway view of an example embodiment of a detector incorporating the invention. FIG. 2B illustrates the operation of the example detector of FIG. 2A.

Example light source 201 emits light in a pattern indicated by vector set 202. Light source 201 may be a light emitting diode (LED) or other kind of light generating device, and is preferably an extended source. That is, light source 201 preferably appears as a light-emitting area, larger than a point source.

Light from light source 201 falls onto convex target 203. Target 203 is reflective, and light is reflected from target 203 with a directional characteristic indicated by vector set 204. While some light is scattered in nearly all directions by target 204, a stronger reflection is seen whose angle of reflection equals the angle of incidence of the light onto target 203. This stronger reflection is called the specular component of the reflection. The scattered light is said to exhibit an approximately Lambertian characteristic. An ideal Lambertian reflector scatters light such that the intensity of the scattered light is proportional to the cosine of the angle between the reflected light and a normal to the reflector surface. For the purposes of this disclosure, a surface that scatters light in substantially all directions will be considered an approximately Lambertian reflector, and will be considered to reflect light in an approximately Lambertian manner.

Possible materials from which target 203 may be made are etched aluminum and white porcelain enamel. Etched aluminum reflects about 50% of the light incident on it in an approximately Lambertian manner, and about 50% specularly. White porcelain enamel reflects about 85% in an approximately Lambertian manner, about 5% specularly, and absorbs about 10% of the light incident on it. A variety of other suitable materials is available as well.

Some of the light reflected from target 203 makes its way into tube 205 and eventually to light sensor 206. Tube 205 serves to limit the field of view of light sensor 206. Light sensor 206 may be an electronic device that changes an operating characteristic in response to the intensity of light falling on it. For example, light sensor 206 may be a photodiode or phototransistor that changes its current conduction in response to light intensity, or it may be a photoresistor that changes its resistance in response to light intensity. By interpreting this change in operating characteristic with appropriate electronic circuitry well known to those skilled in the art, a signal may be produced that indicates the intensity of the light falling on light sensor 206.

The intensity of light falling on light sensor 206 is a convolution over the field of view of sensor 206 (as limited by tube 205), of the directional light emission characteristic of light source 201 and the directional light reflection characteristic of the portion of target 203. Because of the convex shape of target 203, the amount of light received by light sensor 206 will vary depending on what part of target 203 is in the field of view of light sensor 206.

FIG. 3 shows the position detector system in a position that maximizes the light falling on light sensor 206. Whereas in FIG. 2B tube 205 was aimed at the center of target 203, in FIG. 3, tube 205 is aimed just above the center of target 203. The center of target 203 is considered the origin of a Z direction in FIGS. 2B and 3. In the example position of FIG. 3, the specular reflection direction aligns with tube 205. In the previous position shown in FIG. 2B, some of the specular reflection misses tube 205, and therefore the light seen by light sensor 206 is reduced as compared with the position shown in FIG. 3.

In the example embodiment shown, the light source 201 may have a dominant axis 207 in the primary direction of light emission. The components may be placed such that axis 207 of light source 201 approximately intersects the axis 208 of tube 205 approximately at the surface of target 203 when the tube is directed at the apex of the target 203. This arrangement may serve to maximize the available signal from sensor 206.

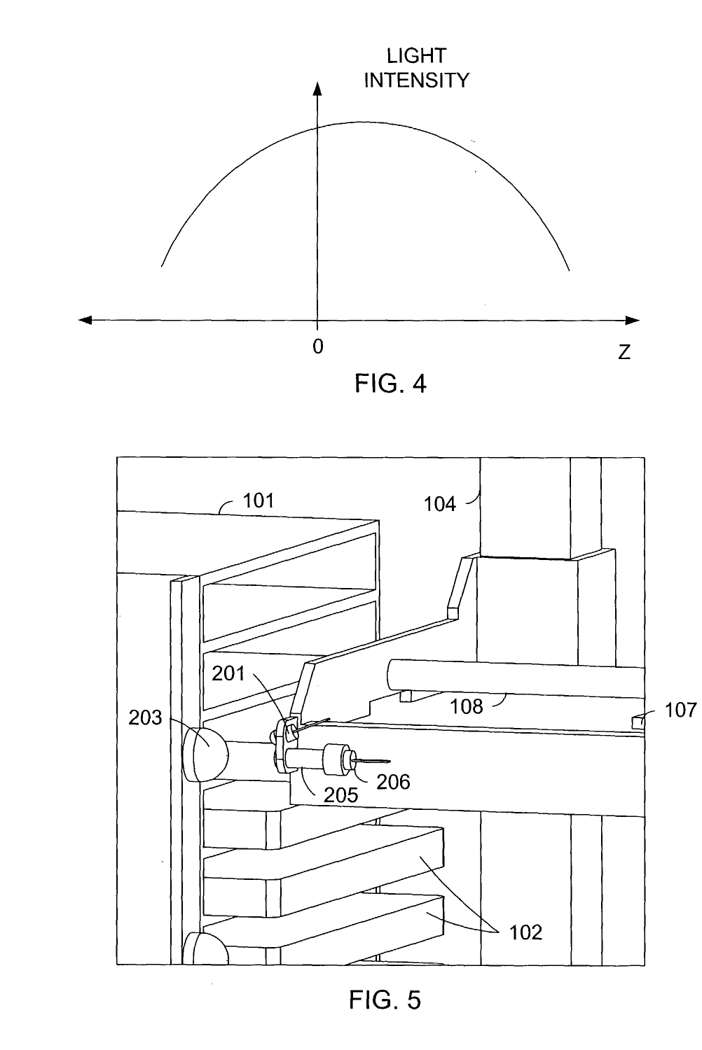

By traversing the height of reflector 203 in the Z direction, a curve may be generated as in FIG. 4. While the actual shape of the curve will depend on the materials and dimensions of a particular embodiment, FIG. 4 serves to demonstrate the qualitative behavior of the system. At some Z location, the light intensity reaching the light sensor 206 is maximized, and the intensity decreases as the position departs from that location.

This property may be used to measure position in a robotic mechanism such as an autochanger system. In an example embodiment, target 203 is large enough that the robotic mechanism can reliably position tube 205 over target 203 without accounting for tolerance variations. A light reading is taken, and the robotic mechanism is moved. A second light reading is taken, and compared with the first. The comparison establishes the relationship of the change in light intensity with a change in position. This information may be used to move in the direction of the peak illumination. Once the peak is found, the mechanism position may be recorded and compared with the nominal position of the target 203. A calibration may thus be constructed for positioning the robotic mechanism accurately despite tolerance variations. One or more targets may be used.

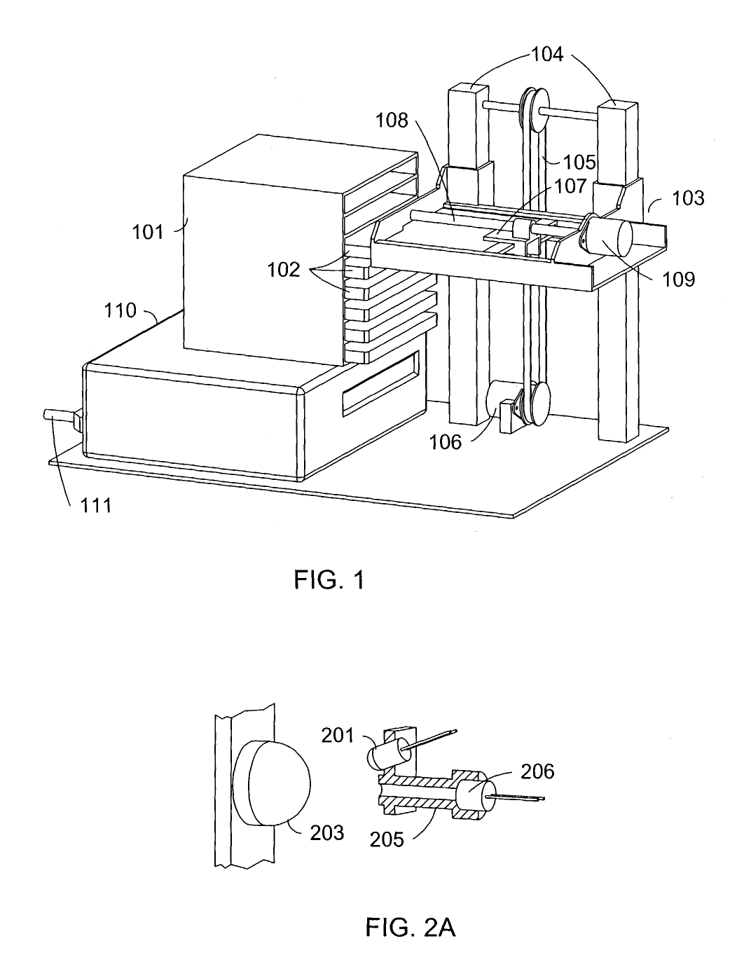

FIG. 5 shows the schematic autochanger system of FIG. 1 with an example embodiment of the position measuring system attached. In the example embodiment of FIGS. 2A-3, target 203 is dome-shaped. That is, it is convex in two dimensions, allowing position to be measured in two dimensions. The dome shape may be a portion of a sphere, an ellipsoid, or some other arbitrary shape.

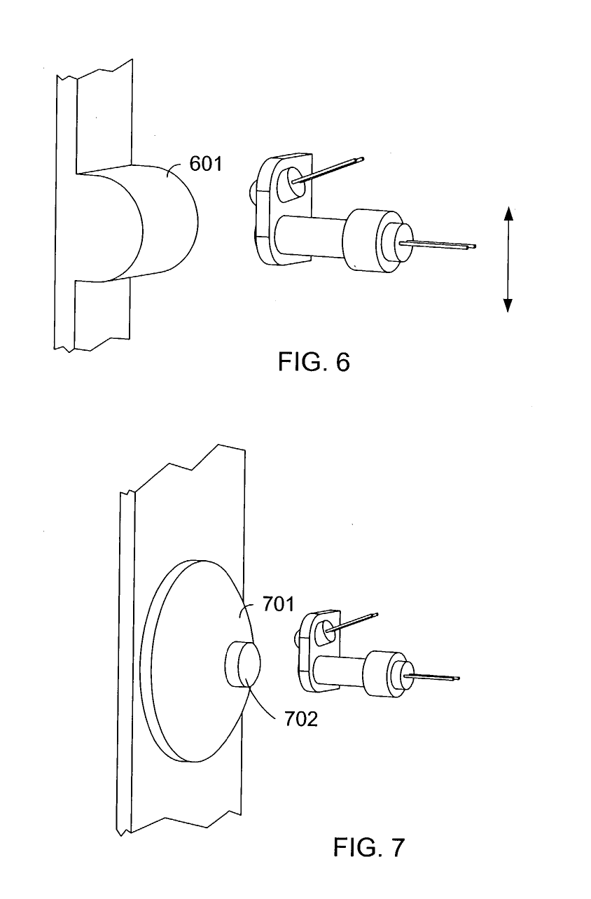

FIG. 6 shows an alternative example target embodiment that may be used if only one direction of motion is to be measured. Example convex target 601 has curvature in only one direction, and is made of a similar material as target 203.

FIG. 7 shows an alternative target embodiment that may allow for a larger search range, thus accommodating robotic mechanism with greater tolerance variations. Example target 701 may also serve to provide higher accuracy, as the small, raised central region 702 may serve to sharpen the peak of the intensity-versus-position curve analogous to the curve in FIG. 4. The curved face of raised central region 702 may have a stronger curvature than the larger apron portion of target 701.

The foregoing description of the present invention has been presented for purposes of illustration and description. It is not intended to be exhaustive or to limit the invention to the precise form disclosed, and other modifications and variations may be possible in light of the above teachings. For example, other materials may be used for the reflective target, or other convex curved target shapes may be utilized. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A position measuring device, comprising:
a) a light source;
b) a convex reflective target, reflecting light from the light source; and
c) a detector, receiving the reflected light in an amount that varies with the relative positions of the detector and the target.

2. The position measuring device of claim 1, further comprising a tube that limits a field of view of the detector.

3. The position measuring device of claim 2, further comprising:
a) a dominant axis of the light source;
b) a surface of the convex reflective target; and
c) an axis of the tube; and
wherein the dominant axis of the light source and the axis of the tube approximately intersect approximately at the surface of the convex reflective target when the tube is directed at an apex of the convex reflective target.

4. The position measuring device of claim 1 wherein the light source is an extended light source.

5. The position measuring device of claim 1 wherein the light source is a light emitting diode.

6. The position measuring device of claim 1, wherein the convex reflective target reflects a first portion of the light incident on it in an approximately Lambertian manner, and reflects at least five percent of the light incident on it in a substantially specular manner.

7. The position measuring device of claim 1 wherein the convex reflective target is dome shaped, having curvature in two dimensions.

8. The position measuring device of claim 1 wherein the convex reflective target has curvature in only one dimension.

9. The position measuring device of claim 1, wherein the convex reflective target further comprises:
a) an apron portion; and
b) a raised central portion.

10. The position measuring device of claim 9, further comprising:
a) a surface of the apron portion, the surface of the apron portion having a first curvature; and
b) a surface of the raised central portion, the surface of the raised central portion having a second curvature.

11. The position measuring device of claim 10 wherein the second curvature is stronger than the first.

12. The position measuring device of claim 1, further comprising a robotic system that moves the detector and the convex target in relation to each other.

13. A mass storage autochanger system incorporating the position measuring device of claim 1.

14. A method of measuring position, comprising the steps of:
a) emitting light from a light source;
b) reflecting a portion of the light from a convex reflector;
c) receiving light with a sensor;
d) arranging the light source, convex reflector, and sensor such that a light intensity received by the sensor varies with a relative position of the sensor and the convex reflector;
e) moving the sensor with respect to the convex reflector; and
f) sensing the light intensity.

15. The method of claim 14 further comprising limiting a field of view of the sensor with a tube.

16. The method of claim 14 further comprising locating the relative position of the sensor and the convex reflector that results in a maximum light intensity.

17. The method of claim 14 wherein the convex reflector is dome shaped.

18. The method of claim 14 wherein the convex reflector has curvature in only one dimension.

19. The method of claim 14 wherein the convex reflector has a raised central portion.

20. The method of claim 14 further comprising the step of moving the light source with the sensor.

21. A position measuring system, comprising:
a) means for emitting light;
b) means for sensing light intensity;
c) means for limiting a field of view of the sensing means;
d) means for producing relative motion; and
e) a convex reflective target, receiving light from the emitting means and reflecting light to the sensing means such that the light intensity sensed by the sensing means varies with a relative position of the sensing means and the convex reflective target.
